(19) United States
(12) Patent Application Publication
(10) Pub. No.: US 2013/0307272 A1
(43) Pub. Date: Nov. 21, 2013

(54) MOBILE HYDRO ELECTRIC DEVICE

(71) Applicant: Maurice Leon Smith, Moseley, VA (US)

(72) Inventor: Maurice Leon Smith, Moseley, VA (US)

(21) Appl. No.: 13/888,997

(22) Filed: May 7, 2013

Related U.S. Application Data
(60) Provisional application No. 61/649,802, filed on May 21, 2012.

(51) Int. Cl. F01D 15/10

(52) U.S. Cl. CPC F01D 15/10; F03B 17/005
USPC 290/50; 290/52; 415/916

(57) ABSTRACT

A hydro electric generating device that is mobile. The hydro electric generating device may include a water tank with a turbine generator suspended within it. Water may be pumped from the bottom of the water tank and to the top of the water tank. The rotating water supply may be directed onto rotor blades of the turbine generator and thereby generate electricity.

### BACKGROUND OF THE INVENTION

The present invention relates to a hydro electric device and, more particularly, to a mobile hydro electric device.

Hydroelectricity is the term referring to electricity generated by hydropower; the production of electrical power through the use of the gravitational force of falling or flowing water. It is the most widely used form of renewable energy, accounting for 16 percent of global electricity generation, 3,427 terawatt-hours of electricity production in 2010, and is expected to increase about 3.1% each year for the next 25 years.

The cost of hydroelectricity is relatively low, making it a competitive source of renewable electricity. The average cost of electricity from a hydro plant larger than 10 megawatts is 3 to 5 U.S. cents per kilowatt-hour. Hydro is also a flexible source of electricity since plants can be ramped up and down very quickly to adapt to changing energy demands. However, damming interrupts the flow of rivers and can harm local ecosystems, and building large dams and reservoirs often involves displacing people and wildlife. Further, the macro-systems are built for states, cities, and towns and may not be used in individual settings such as businesses and homes.

As can be seen, there is a need for a mobile hydro-electric device.

### SUMMARY OF THE INVENTION

In one aspect of the present invention, a mobile hydro-electric device comprises: a water tank having a bottom, a top, and a sidewall; a turbine generator comprising rotor blades, suspended in the water tank; an exit hose having a first end and a second end, wherein the first end of the exit hose is connected to an exit port near the bottom of the water tank and the second end of the exit hose is connected to an entry port near a top end of the water tank; a water pump attached to the exit hose; and a battery attached to the turbine generator via an electrical connection and attached to the water pump via the electrical connection.

In another aspect of the present invention, a method of generating an output of electricity comprises, placing water inside a water tank; pumping water in the water tank from a bottom of the tank to a top of the tank; spraying water onto a rotor blade of a turbine generator; generating electricity within the turbine generator; and transferring electricity from the turbine generator to a water pump and an AC/DC converter.

These and other features, aspects and advantages of the present invention will become better understood with reference to the following drawings, description and claims.

### BRIEF DESCRIPTION OF THE DRAWINGS

FIG. 1 is a top view illustrating a cap component and a clip component of the present invention; and

FIG. 2 is a section detail view of the present invention along line 1-1 in FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a hydro electric generating device that is mobile. The hydro electric generating device may include a water tank with a turbine generator suspended within it. Water may be pumped from the bottom of the water tank and to the top of the water tank. The water may be directed onto rotor blades of the turbine generator and thereby generate electricity.

The present invention may include a mobile hydro-electric device that may create renewable energy by using micro-hydro electric applications. The mobile micro-hydro electric device may be used for automobiles, business, and homes. Increased electrical output may be achieved using a larger water pump, a larger pressure tank, and a larger turbine that may increase water flow and generate more electricity.

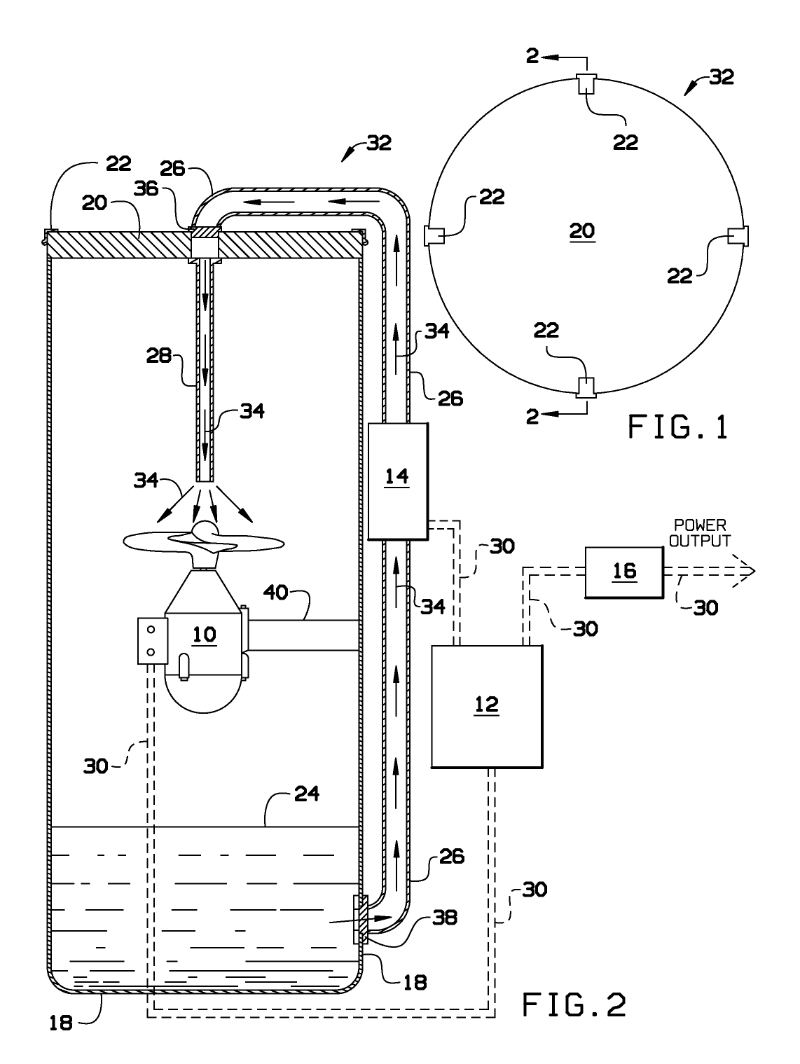

Referring to FIGS. 1 and 2, the present invention may include a water tank 18. In certain embodiments, the water tank 18 may be a 95 gallon vertical steel water tank. The water tank 18 may include a top end, a bottom end, and sidewalls. The water 24 may enter the water tank 18 near the top end, and the bottom end of the water tank 18 may store the water 24.

The present invention may include a turbine generator 10. The turbine generator 10 may be a 12 volt turbine generator 10. The turbine generator 10 may be suspended within the water tank 18 above or below the water 24 line. The turbine generator may include rotor blades. The turbine generator 10 may be mounted to the sidewalls of the tank 18 by a tube clamp 40 that may surround and support the turbine generator 10. The tube clamp 40 may attach to the turbine generator 10 using brackets.

In certain embodiments, the present invention may further include an exit hose 26 and an entrance hose 28. The exit hose 26 may be located near the bottom end of the tank 18. As illustrated in the Figures, the water 24 may be pumped from the bottom of the tank 18 through an exit port 38 and into the exit hose. A water pump 14 may be attached to the exit hose 26 and may pump water from the bottom of the water tank 18 to the top of the water tank 18. The water 24 may flow 34 through the exit hose 26 and through an input hose 28. An entry port 36 may be located near the top end of the water tank 18. The water flow 34 may then enter the entrance hose 28 and onto the rotor blades of the turbine generator 10. The entrance hose 28 may be pointed towards the rotor blades.

In certain embodiments, the present invention may include a cap 20. The cap 20 may cover the water tank 18. As illustrated in FIG. 1, the cap 20 may be circular and may fit on top of the water tank 18. The cap 20 may be releasably fastened to the water tank 18 by clips 22, or any other fastening component. In certain embodiments, the cap 20 may include the entry port 36, in which the entrance hose 28 may connect.

In certain embodiments, the present invention may include an input valve and an exit valve. The input valve and the exit valve may be about ¾ inches valves. The input valve may receive a water hose to fill the tank 18. When the tank 18 is to be stored or transported, the exit valve may be opened to release the water 24 from the tank 18.

In use, the water 24 may flow from the bottom of the tank 18 and into the exit hose 26 through the exit port 36. The water 24 may be pumped up the exit hose 26 to the top of the water tank 18, through the entrance hose 28 and into the water tank 18. The entrance hose 28 may be positioned to direct the incoming water 34 onto the blades of the turbine generator. The flowing water 34 may turn the blades and thereby turn the turbine generator 10 to create electricity. The electricity may flow from the turbine generator 10 to a battery or battery rack 12 via an electrical connection 30. The battery or battery rack 12 may connect with the pump 14 via the electrical connection 30 and power the pump 14. The battery or battery rack 12 may also connect with an AC-DC converter 16 for power output. The micro-hydro electric device may generate a steady water flow at 10 KPM and may produce 1.5 Kilowatts per day. The output may be increased by using a larger water pump 14 and a larger tank 18 to increase output power.

The present invention may be a reliable source of electricity for: homes, business, cars, boats, and powered equipment and the like. A person may use this Micro-Hydro Electric Device on a camping trip, or to reduce electricity bills as long as one has a supply of water available. The present invention may provide electricity all day and night. Organizations and people may use the mobile system when there is a power outage, or use to reduce electrical cost.

It should be understood, of course, that the foregoing relates to exemplary embodiments of the invention and that modifications may be made without departing from the spirit and scope of the invention as set forth in the following claims.

What is claimed is:

1. A mobile hydro-electric device comprising:
a water tank having a bottom, a top, and a sidewall;
a turbine generator comprising rotor blades, suspended in the water tank;
an exit hose having a first end and a second end, wherein the first end of the exit hose is connected to an exit port near the bottom of the water tank and the second end of the exit hose is connected to an entry port near a top end of the water tank;
a water pump attached to the exit hose; and
a battery attached to the turbine generator via an electrical connection and attached to the water pump via the electrical connection.

2. The mobile hydro-electric device of claim 1, further comprising an entrance hose connected to the exit hose and extending into the water tank.

3. The mobile hydro-electric device of claim 2, wherein the entrance hose is pointed towards the rotor blades of the turbine generator.

4. The mobile hydro-electric device of claim 1, further comprising a cap releasably secured to the top of the water tank.

5. The mobile hydro-electric device of claim 4, wherein the cap is releasably secured to the top of the water tank by at least one clip.

6. The mobile hydro-electric device of claim 1, wherein the turbine generator is attached to the sidewall of the water tank by a wrap around clamp with brackets.

7. The mobile hydro-electric device of claim 1, wherein the battery is connected to an AC-DC converter.

8. A method of generating an output of electricity comprising,
placing water inside a water tank;
pumping water in the water tank from a bottom of the tank to a top of the tank;
spraying water onto a rotor blade of a turbine generator;
generating electricity within the turbine generator; and
transferring electricity from the turbine generator to a water pump and an AC/DC converter.
